(19) United States
(12) Patent Application Publication
(10) Pub. No.: US 2026/0329366 A1
(43) Pub. Date: Oct. 22, 2026

(54) USER-PROGRAMMABLE ADAPTIVE POWER CONTROLS WITH EBPF

(71) Applicant: Intel Products IP LLC, Santa Clara, CA (US)

(72) Inventor: Christopher MACNAMARA, Limerick (IE)

(21) Appl. No.: 19/697,010

(22) Filed: Jun. 3, 2026

(51) Int. Cl. G06F 1/3296; G06F 1/3206

(52) U.S. Cl. CPC G06F 1/3296; G06F 1/3206

(57) ABSTRACT

Methods, software, and apparatus for user-programmable adaptive power controls with Extended Berkely Packet Filter (eBPF). An eBPF governor is loaded from user space into a kernel space of an operating system and is used to collect telemetry data relating to power management and performance metrics and events, which is stored in the kernel space. Data relating to the power management and performance metrics and events is read from the kernel space into the user space and is used by a power controller to dynamically adjusted at least one of a frequency of one or more of CPU cores, an idle state for one or more of the CPU cores, and a frequency for the uncore of a CPU. In one aspect, the eBPF governor is attached to one or more attachment points that facilitate access to one or more of tracepoints, kernel probes, and performance events comprising the telemetry date.

### BACKGROUND INFORMATION

Governors are software-based utilities and mechanisms used to regulate system resources such as CPU (Central Processing Unit), memory, and Input/Output (I/O), and to manage process priority, optimize performance, and prevent runaway applications. Power governor are used for regulating power consumed by system resources. Existing kernel governors, such as used in Linux and Microsoft Windows operating systems are static and typically pre-defined with specific use cases in mind. These governors are limited in their use and do not work for a significant number of workloads. As a result, the governors are often disabled in production environments.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein like reference numerals refer to like parts throughout the various views unless otherwise specified:

FIG. 1 is diagram illustrating selected components of an eBPF with power management architecture, according to one embodiment;

FIG. 2 is a flowchart illustrating an eBPF-based governor workflow, according to one embodiment;

FIG. 3 is a diagram illustrating new eBPF-based governors and associated user space daemons on eBPF, according to one embodiment;

FIG. 4 is a diagram illustrating a system architecture supporting enhanced eBPF observability tools, according to one embodiment;

FIGS. 5a and 5b are diagrams of respective embodiments of software architectures illustrating user space and kernel space components; and

FIG. 6 is a diagram of a compute node or compute platform that may be implemented with aspects of the embodiments described and illustrated herein.

### DETAILED DESCRIPTION

Embodiments of methods, software, and apparatus for user-programmable adaptive power controls with Extended Berkely Packet Filter (eBPF) are described herein. In the following description, numerous specific details are set forth to provide a thorough understanding of embodiments disclosed herein. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments describe and illustrated herein, solutions are provided for integrating power management technology into the Linux eBPF framework, unlocking a highly differentiated and largely unexplored design space. By combining eBPF's deep system visibility, near zero overhead, and strong safety guarantees, solutions can be implemented that enable adaptive, policy driven power control that goes beyond the limits of today's static kernel power subsystems. This approach has the potential to accelerate adoption of advanced power features on CPUs while unlocking substantial gains in performance per watt across client, edge, and data center workloads

In accordance with some aspects, an eBPF based power monitor and governor works by embedding fast, customizable, low overhead decision logic directly into the Linux kernel's power subsystem. This allows faster and more accurate power decisions, QoS aware frequency and idle-state control, cross subsystem coordination (e.g., memory system bandwidth and CPU subsystem utilization), improved power efficiency for modern, bursty workloads, and safe, dynamic deployment without kernel changes, among other improvements.

eBPF runs inside the Linux kernel with minimal overhead, allowing highly efficient tracking of CPU frequency changes, idle states, and energy-related kernel events without costly context switches. This provides granular, real-time insight into power behaviour that traditional user-space tools cannot match. It allows access to kernel data structures and events normally inaccessible to user-space agents, enabling richer insights with far lower performance cost. eBPF programs can be added, updated, and removed dynamically—no reboot or kernel rebuild required.

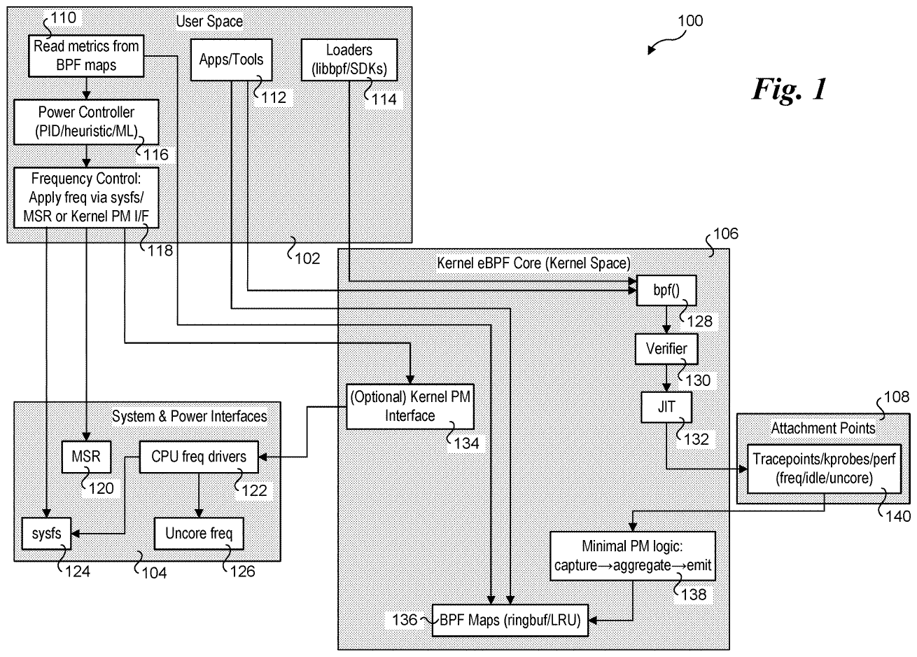

FIG. 1 shows a diagram 100 illustrating selected components of an eBPF with power management architecture, according to one embodiment. The components are grouped into user space 102, system & power interfaces 104, kernel eBPF core 106 operating in kernel space, and attachment points 108.

Components implemented in user space 102 include read metrics from BPF maps block 110, applications and tools 112, loaders 114, a power controller 116, and a frequency control block 118 that applies frequencies via sysfs and model specific registers (MSR) or via a kernel power management (PM) interface. In the illustrated embodiment, loaders 114 included Linux libbfp and associated SDKs (software development kits).

System and power interfaces 104 include MSR 120, CPU (central processing unit) frequency drivers 122, sysfs 124, and uncore frequency 126. sysfs is a component provided by the Linux kernel that enables kernel code to export information to user processes via an in-memory file system. This includes exporting information about various kernel subsystems, hardware devices, and associated device drivers from the kernel's device model to user space. As used herein, uncore frequency is the frequency used for various components/blocks on a CPU or System on a Chip (SoC) that is outside the processor cores.

Kernel eBPF core 106 are the eBPF core components implemented in the kernel and include a bpf( ) application program interface (API) 128, an eBPF code verifier 130, a just-in-time (JIT) compiler 132, an optional kernel PM interface 134, BPF maps 136, and a minimal power management (PM) block 138. bpf( ) API 128 operates as a Linux kernel API that enables eBPF programs (code) to be loaded into the Linux kernel. Attachment points 108 includes tracepoints, kernel probes (kprobes), and perf block 140. The attachment points are used to control/adjust processor core frequencies, idle states, and uncore frequencies.

Loader 114 in user space 102 are used to load eBPF programs into kernel space via bpf( ) API 128, while read metrics from BPF maps block 110 reads aggregated metrics from BPF maps 136. Power controller 116 consumes map data received from read metrics from BPF maps block 110 and implements a control loop using one of more of a PI (proportional-integral), PID (proportional-integral-derivative), heuristic, or machine learning (ML) algorithms to drive changes by providing frequency control inputs to frequency control block 118. Frequency control block 118 is also used to apply changes by connecting to sysfs 124 and MSR 120 or kernel PM interface 134.

The components in kernel eBPF core 106 are used to attach to stable tracepoints/perf events (freq, idle, uncore), as represented by kprobes/tracepoints/perf events under attachment points 108. The kernel eBPF core also maintain per-CPU/per-package metrics in BPF maps 136, as depicted by minimal PM logic block 138→BPF maps 136. In one embodiment, BPF map 136 comprises a ring buffer that holds ring buffer events and operates as a type of database. In one embodiment the ring buffer uses a least recently used (LRU) hash for MAs. Minimal PM logic keeps the kernel logic at a minimal level. In one embodiment minimal PM logic implements capture→aggregate→emit scheme with no policy loops in eBPF.

The eBPF with power management architecture enables custom eBPF power management programs to be loaded from user space into the kernel using loaders 114. The loaders use the bpf( ) function calls, which operate as an API into the Linux kernel. The eBPF verifier 130 is used to verify the eBPF program, which comprises eBPF type code that is compiled using JIT compiler 132. The eBPF code is generally implemented as observability code or governors that is inserted into the kernel using the foregoing mechanism.

In one embodiment, tracepoints, kprobes, and perf block 140 include some predefined trace points and performance events in the kernel. Generally, a trace point is a function or a symbol, or a metric that can be extracted via the compiled eBPF program. For example, these might include frequency idler, encore frequency, or encore status, C-state residency, etc.

The capture, aggregate, and emit operations essentially take the attached functions, symbols, and/or metrics and adds them as ring buffer events to BPF maps 136. Those ring buffer events are exposed to and read by read metric from BPF maps block 110, as discussed above.

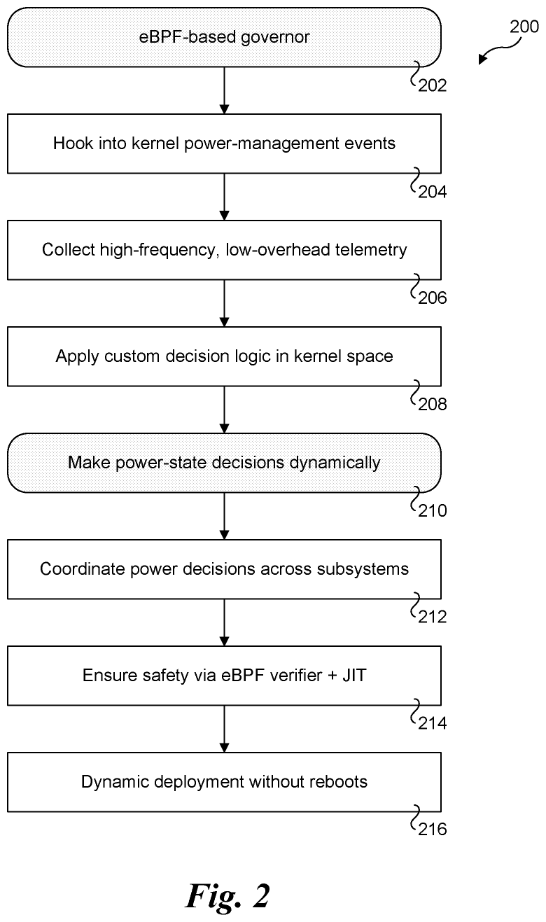

FIG. 2 shows a flowchart 200 illustrating an eBPF-based governor workflow, according to one embodiment. The workflow begins with an eBPF-based governor 202. The eBPF-based governor hooks into kernel power-management events that are maintained in BPF maps 136, gathers high-frequency, low-overhead telemetry data, and applies custom decision logic in the kernel space, as respectively shown in blocks 204, 206, and 208.

As shown in a block 210, the eBPF-based governor makes power-state decisions dynamically. This entails coordinating power decisions across subsystems, ensuring safety via eBPF verifier 130 and JIT compiler 132, and dynamic deployments without reboots, as respectively shown blocks 212, 214, and 216.

Another aspect of the eBPF-based governor architecture is to implement a pluggable power policy engine where the policies are eBPF programs. User space daemons are also used to load policies, while custom eBPF-based governors are used to implement the policies.

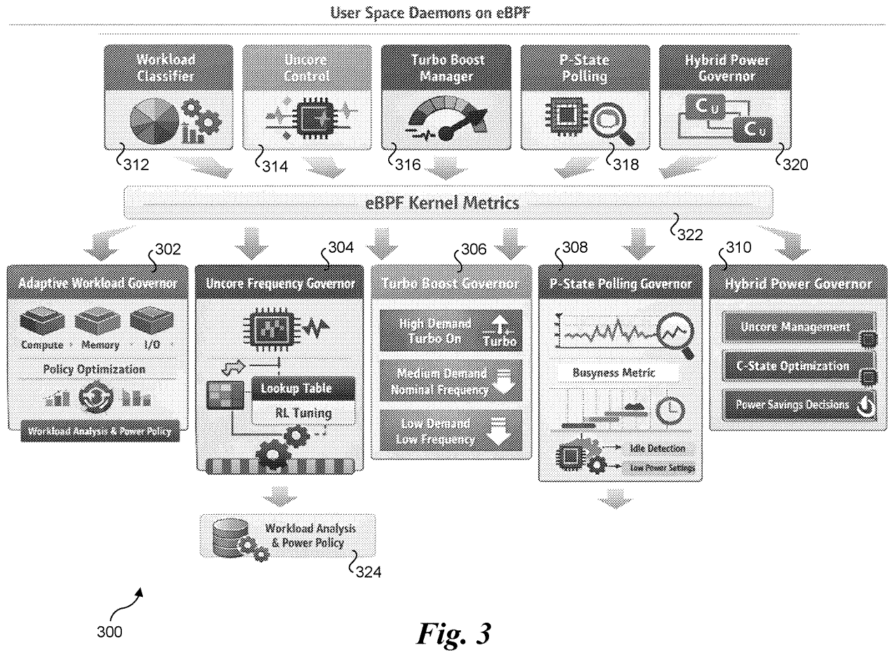

FIG. 3 shows a diagram 300 illustrating new eBPF-based governors and associated user space daemons on eBPF, according to one embodiment. The eBPF-based governors include an adaptive workload governor 302, an uncore frequency governor 304, a turbo boost governor 306, a P-state (power state) polling governor 308, and a hybrid power governor 310. The user space daemons on eBPF include a workload classifier 312, an uncore control block 314, a turbo boost manager 316, a P-State polling block 318, and a hybrid power governor user space daemon 320. The user space daemons on eBPF output eBPF kernel metrics 322 that are used for associated eBPF-based governors that reside in the kernel. The.

Adaptive workload governor 302 is used to govern adaptive workloads. It puts compute, memory, io bound metric collection, and workload classification metrics into groups and implements an algorithm that generates a power policy. This results in application specific optimisation depending on workload types deployed to a node. Optimization goals differ for each workload type, e.g., IO bound require high uncore, compute bound required high frequencies and can reduce uncore freq=Perf/watt. TABLE 1 shows how different workload types affect core utilization, IO utilization, and memory bandwidth utilization.

TABLE 1

| | Core | IO | Mem B/W |
|---|---|---|---|
| Workload Type | Utilisation | Utilisation | Utilisation |
| Compute Bound “A” | High | Low | Low |
| | (user app) | | |
| I/O Bound “B” | Low | High | Varies |
| | | (waiting) | |
| Memory Bound “C” | Varies | Varies | High |

Compute Bound workloads are not waiting on resources (IO-mem) and little time running kernel code, with high core utilization. IO bound workloads are waiting on resources (IO-mem), with low CPU utilization. Memory bound workloads are waiting on memory, cache misses are a feature, and sometimes have high core utilisation

Uncore frequency governor 304 is an AI-driven governor that is used to implement an uncore frequency controller based on utilisation with thresholds for entering to max uncore frequency. The governor inputs are utilisation per core, then a lookup table is used to determine if lowering uncore is the correct action. In one embodiment the lookup table is built with reinforcement learning (RL) and is user programmable (e.g., the user can provide RL tuning), enabling adjustment of compute uncore power settings. Uncore frequency governor 304 also outputs workload analysis and power policy 324 that is for the uncore components in the processor.

Turbo boost governor 306 is used to govern performance at different application demand points. At a user decided and programmed application utilisation threshold, it may activate or deactivate turbo boost to address high performance application needs by increasing the frequency on a subset or all CPU cores. Below a user defined threshold, the turbo governor will set a nominal frequency, and below another threshold a low frequency point. This will depends on the capacity of the application and the capacity of the core and the utilisation.

P-state polling governor 308 implements P-state polling of software threads that are running continuously but not exercising real work. In one embodiment, a “busyness” metric in the kernel is created and used by this governor. This governor may also be used for idle detection and low power settings.

Hybrid power governor 310 is a cross-technology (C/uncore) hybrid power governor that combines the best of uncore and C states, resulting in lower power consumption. It uses an eBPF probe into the scheduler, C state residency, and uncore frequency and makes power saving decisions. Hybrid power governor 310 is also used to perform uncore management and C-State optimization.

Hybrid power governor 310 intelligently combines core C state residency with uncore frequency scaling to deliver deeper idle power savings without harming performance, enabling more efficient operations. It combines uncore frequency+C states to capture true idleness (cores+fabric) and unlocks extra package power savings without performance hits. It also provides functionality that extends beyond today's single technology (C state or P state) governors.

In one embodiment the inputs to the hybrid power governor include per-core utilization (scheduler stats), C state residency (per-core CC6+, package), IO bandwidth (blk layer+queue stats), memory bandwidth (IMC (integrated memory controller)/uncore PMU (power management unit)) or LLC (last level cache) (miss proxy), and thermals/power caps.

Another aspect of the hybrid power governor is filtering and associated features. These include sliding windows (e.g., 20-100 ms), exponential moving average smoothing, and hysteresis/debounce. Exemplary derived signals include all_cores_low, cc6_residency≥99%, io_bw_low, mem_bw_low, and a combined weighted_idle_score.

The hybrid power governor also includes a decision engine. The decision engine employs rules to scale uncore down only when all low load predicates hold, an idle detector to scale down uncore during platform idle, a PI/PID controller to avoid oscillation, and a state machine to enforce minimum residency and ramp rate limits.

In one embodiment, the hybrid power governor includes the following actuators: Request uncore frequency changes via dedicated driver hooks (PoC), leave core C states under OS control; sysfs/debugfs tunables for thresholds, floors/ceilings, windows; and tracepoints for telemetry and A/B testing. The hybrid power governor may also implement safety and fallback features such as latency guardrails (tail p95/p99), thermal/power ceilings, fast rollback on performance regression, and panic free fallback to a stock governor.

### Observability Tools

The eBPF architecture and framework may also be used to enhance observability. eBPF governors and eBPF programs targeted at observability will enable user space applications and the like to not only have improved observation of platform events but also be able to access causal information. For example, compare the following.

Today, a sampling model with powertop periodically observes a CPU state such as “something woke the CPU up,” but provides no or little insight into the cause of the event. For instance, the observation may include.
to: CPU in C6
t1: CPU in C0
t2: Freq 3.2 GHZ

Under an eBPF observability tool(s), the following may be observed.
sched_wakeup→tid=123→comm=pkt-fwd
cpu_idle_exit→state=C6
cpu_frequency→old-800 MHz new=3200 MHz
irq_handler_entry→net_rx

With these addition observation details, we can now observe, “Thread X caused the CPU to exit C6 via sched_wakeup, triggered by IRQ Y, leading to a frequency ramp.”

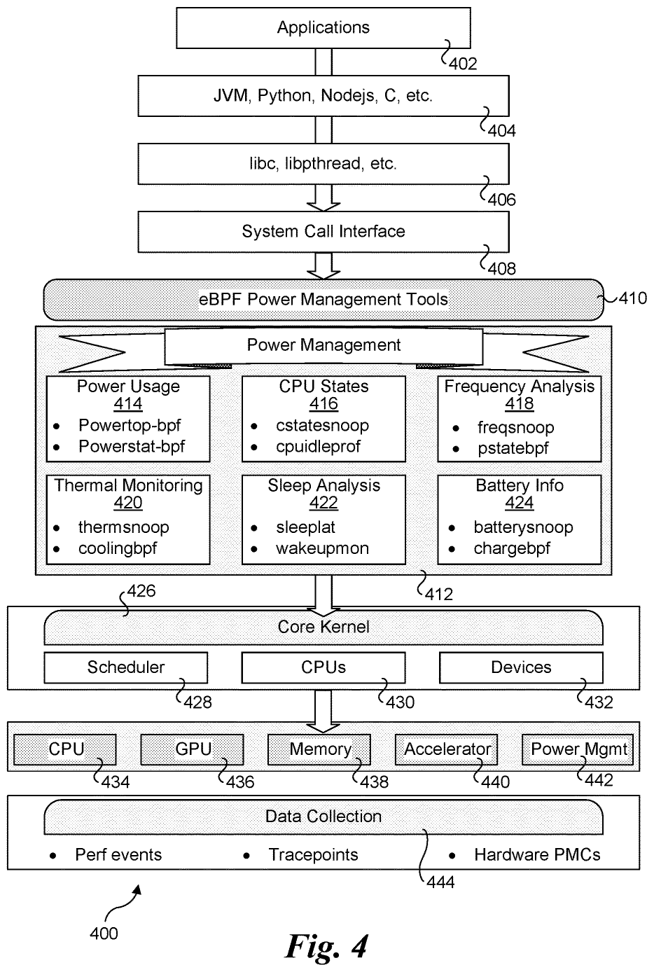

FIG. 4 shows a system architecture 400 supporting enhanced eBPF observability tools. Architecture 400 includes applications 402 running in user space that are programmed using program languages 404 and libraries/frameworks 406. These applications (e.g., eBPF programs) access eBPF power tools 410 via a system call interface 408, such as using bpf( ) system calls.

The exemplary eBPF power management tools 412 include power usage tools 414, CPU state tools 416, frequency analysis tools 418, thermal monitoring tools 420, sleep analysis tools 422 and battery information tools 424. The eBPF power management tools are enabled to access core kernel 426, which provides access to a schedular 428, CPUs 430, and devices 432. This provides observability of a CPU 434, a GPU 436, memory 438, an accelerator 440, and power management hardware 442. Data collection 444, including performance events, tracepoints, and hardware performance monitor counters (PMCs), is used to populate the observability data that are available to the eBPF power management tools.

Exemplary eBPF power management tools are shown in TABLE 2 below.

TABLE 2

| | |
|---|---|
| powertop-bpf | eBPF-based power attribution vs sampling model |
| | (Powertop-like, but trace-driven) |
| powerstat-bpf | Energy / pkg / domain deltas over workload time |
| cstatesnoop | Tracing entry/exit + residency of CPU C-states |
| pstatebpf | Observing frequency transitions + governors |
| thermsnoop | Thermal zone events, throttling causes |
| Batterysnoop? | Platform energy source / discharge attribution |

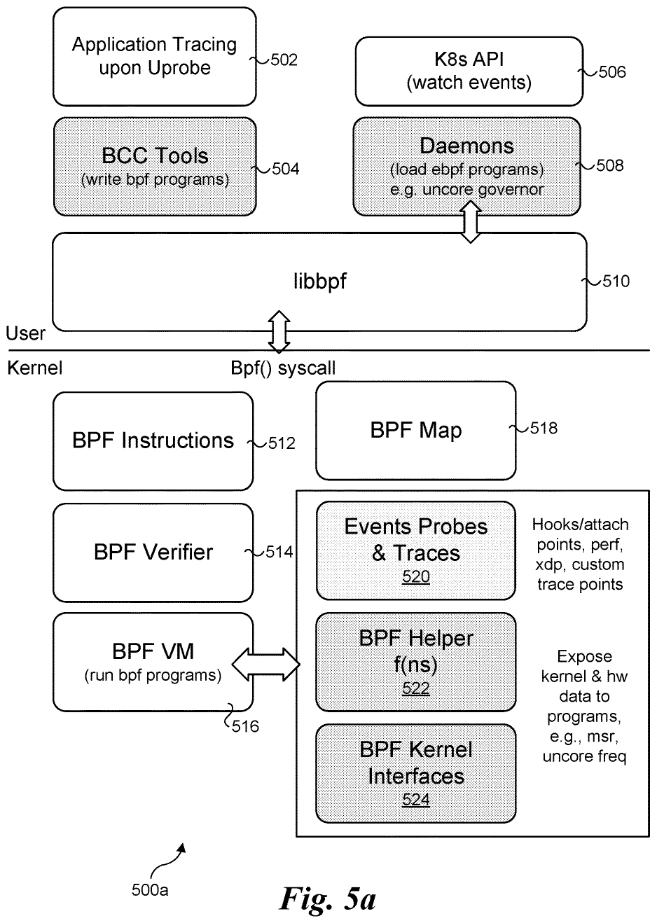

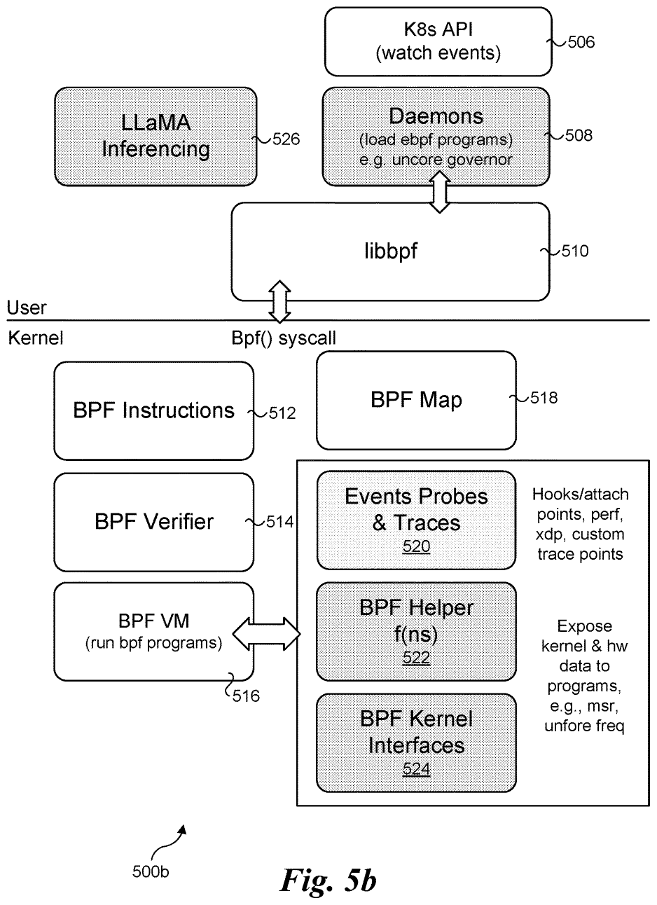

FIG. 5a shows a software architecture 500a that is used by some embodiments. The architecture is divided into user space and kernel space. In this diagram and the diagram for software architecture 500b of FIG. 5b, components shown with a white background are existing components while components shown with a gray background are new components.

The user space components include application tracing upon Uprobe 502, BCC tools 504 that are used to write bpf programs), K8s API (watch events) 506, daemons 508 and llbbpf 510. Existing kernel components include BPF instructions 512, a BPF verifier 514, a BPF virtual machine (VM) 516, and a BPF map 518. New kernel components include events probes and traces 520, BPF helper functions 522, and BPF kernel interfaces 524. Events probes and traces 520 comprise kernel hooks/attach points, perf, xdp (eXpress data path), and custom trace points. BPF helper functions 522 and BPF kernel interfaces 524 expose kernel and hardware data to program, such as MSR and uncore frequency.

As further shown in architecture diagrams 500a and 500b, llbbpf communicates with kernel components using Bpf( ) syscalls.

Like-numbered components in software architectures 500a of FIGS. 5a and 500b of FIG. 5b are the same or similar components under both software architectures. Software architectures 500b further includes LLAMA inferencing 526, which is an example of inferencing for a Large Language Model (LLM).

### Example Platform/Compute Node

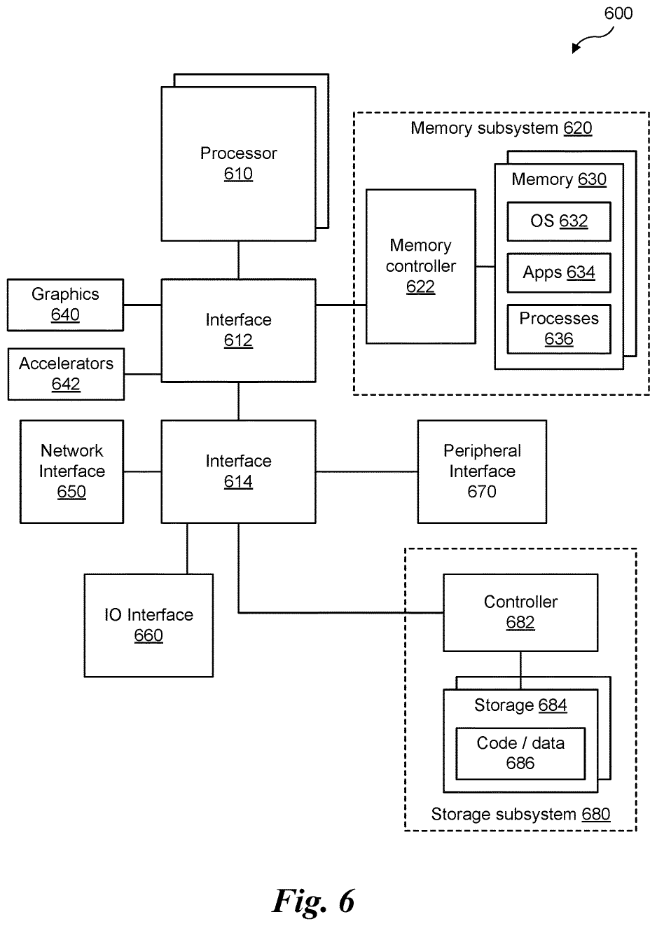

FIG. 6 depicts a compute node 600 in which aspects of the embodiments disclosed above may be implemented. Compute node 600, also referred to as a compute platform, includes one or more processors 610, which provides processing, operation management, and execution of instructions for compute node 600. Processor 610 can include any type of microprocessor, central processing unit (CPU), graphics processing unit (GPU), processing core, multi-core processor or other processing hardware to provide processing for compute node 600, or a combination of processors. For the embodiments herein, processor 610 is a multi-core processor comprising a System on a Chip (SoC) or System on Package (SoP). Processor 610 controls the overall operation of compute node 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, compute node 600 includes interface 612 coupled to processor 610, which can represent a higher speed interface or a high throughput interface for system components that needs higher bandwidth connections, such as memory subsystem 620 or optional graphics interface 640 components, or optional accelerators 642. Interface 612 represents an interface circuit, which can be a standalone component or integrated onto a processor die. Where present, graphics interface 640 interfaces to graphics components for providing a visual display to a user of compute node 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

In some embodiments, accelerators 642 can be a fixed function offload engine that can be accessed or used by a processor 610. For example, an accelerator among accelerators 642 can provide data compression capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of compute node 600 and provides storage for code to be executed by processor 610, or data values to be used in executing a routine. Memory subsystem 620 can include memory 630 with one or more memory devices such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in compute node 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for compute node 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that compute node 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, compute node 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides compute node 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. Various embodiments can be used in connection with network interface 650, processor 610, and memory subsystem 620.

In one example, compute node 600 includes one or more IO interface(s) 660. IO interface 660 can include one or more interface components through which a user interacts with compute node 600 (e.g., audio, alphanumeric, tactile/touch, or other interfacing). Peripheral interface 670 can include any hardware interface not specifically mentioned above. Peripherals refer generally to devices that connect dependently to compute node 600. A dependent connection is one where compute node 600 provides the software platform or hardware platform or both on which operation executes, and with which a user interacts.

In one example, compute node 600 includes storage subsystem 680 to store data in a nonvolatile manner. In one example, in certain system implementations, at least certain components of storage subsystem 680 can overlap with components of memory subsystem 620. Storage subsystem 680 includes storage 684 including one or more storage devices, which can be or include any conventional medium for storing large amounts of data in a nonvolatile manner, such as one or more magnetic, solid state, or optical based disks, or a combination. Storage 684 holds code or instructions and data 686 in a persistent state (i.e., the value is retained despite interruption of power to compute node 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to compute node 600). In one example, storage subsystem 680 includes controller 682 to interface with storage 684. In one example controller 682 is a physical part of interface 614 or processor 610 or can include circuits or logic in both processor 610 and interface 614.

Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory, JESD235B, originally published in December 2018, HBM2 (HBM version 2, JESD235D, originally published in March 2021, HBM3 (HBM version 3, JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of compute node 600. More specifically, power source typically interfaces to one or multiple power supplies in compute node 600 to provide power to the components of compute node 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, compute node 600 can be implemented using interconnected compute sleds of processors, memories, storages, network interfaces, and other components. In some implementations, a disaggregated architecture under which compute, memory, and storage and pooled in respective interconnect sleds or chassis in racks. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (ROCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

While the embodiments described and illustrated herein refer to Linux eBPF components, similar eBPF components may be implemented in versions of Windows operating systems supporting eBPF.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”). In some instances, including the claims, the terms CPU and SoC or SoP are interchangeable.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments may be used as or to support a software program, software modules, firmware, and/or distributed software executed upon some form of processor, processing core, or embedded logic, or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the embodiments to the precise forms disclosed. While specific embodiments of, and examples for, the teachings and principles are described herein for illustrative purposes, various equivalent modifications are possible within the scope of the claims, as those skilled in the relevant art will recognize.

These modifications can be made to the embodiments in light of the above detailed description. The terms used in the following claims should not be construed to limit the claim scope to the specific embodiments disclosed in the specification and the drawings. Rather, the scope of the claims is to be determined entirely by the following claims, which are to be construed in accordance with established doctrines of claim interpretation.

What is claimed is:

1. A method implemented on a compute platform or system including a central processing unit (CPU) having multiple CPU cores on which software including an operating system is executed and having an uncore comprising circuitry separate from the multiple CPU cores, the method comprising:
loading an extended Berkely Packet Filter (eBPF) governor from user space into a kernel space of the operating system;
collecting, using the eBPF governor, telemetry data relating to power management and performance metrics and events and storing data relating to power management and performance metrics and events in kernel space;
reading data relating to the power management and performance metrics and events from the kernel space into the user space; and
dynamically adjusting, based on the power management and performance metrics and events and using one or more processes executing in user space, at least one of,
a frequency of one or more of the CPU cores,
an idle state for one or more of the CPU cores; or
a frequency for the uncore.

2. The method of claim 1, wherein collecting the telemetry data relating to power management and performance metrics and events comprises attaching the eBPF governor to one or more attachment points that facilitate access to one or more of tracepoints, kernel probes (kprobes), and performance events.

3. The method of claim 1, further comprising storing data relating to power management and performance metrics and events in a BPF map implemented in the kernel space.

4. The method of claim 3, further comprising implementing logic in the kernel space that accesses the one or more of tracepoints, kprobes, or performance events and adds corresponding data to the BPF map.

5. The method of claim 1, wherein the eBPF governor is a user customized eBPF governor, further comprising performing at least one of:
verifying the user customized eBPF governor using a verifier implemented in the kernel space; and
when the eBPF governor comprises eBPF byte code, performing just-in-time compilation of the eBPF byte code via a JIT component implemented in the kernel space.

6. The method of claim 1, wherein the at least one of frequency and idle state for one or more of the CPU cores and frequency for the uncore is dynamically adjusted via a power controller algorithm comprising one or more of a proportional-integral (PI), proportional-integral-derivative (PID), heuristic, and machine learning algorithm.

7. The method of claim 1, wherein the compute platform or system includes a Graphics Processor Unit (GPU), further comprising:
gathering telemetry data relating to power management and performance metrics and events for the GPU;
reading, using a process executing in user space, data relating to the power management and performance metrics and events for the GPU; and
performing power management of the GPU based on the power management and performance metrics and events for the GPU and using one or more processes executing in user space.

8. The method of claim 1, wherein the compute platform or system includes an accelerator, further comprising:
gathering telemetry data relating to power management and performance metrics and events for the accelerator;
reading, using a process executing in user space, data relating to the power management and performance metrics and events for the accelerator; and
performing power management of the accelerator based on the power management and performance metrics and events for the accelerator and using one or more processes executing in user space.

9. The method of claim 1, wherein the operating system comprises a Linux operating system.

10. The method of claim 1, wherein the operating system is a Windows operating system.

11. A non-transitory machine-readable medium having first instructions stored thereon configured to executed on a central processing unit (CPU) of a compute platform having multiple CPU cores and having an uncore comprising circuitry separate from the multiple CPU cores, wherein execution of the first instructions enable the compute platform to:
load an extended Berkely Packet Filter (eBPF) governor from a user space into a kernel space of an operating system of the compute platform;
read data relating to power management and performance metrics and events that have been collected and stored in the kernel space; and
dynamically adjust, based on the power management and performance metrics and events, at least one of,
a frequency of one or more of the CPU cores,
an idle state for one or more of the CPU cores; or
a frequency for the uncore,
wherein the first instructions are configured to be run in the user space.

12. The non-transitory machine-readable medium of claim 11, wherein a portion of the first instructions comprises a power controller that performs the dynamic adjustment using an algorithm comprising one or more of a proportional-integral (PI), proportional-integral-derivative (PID), heuristic, and machine learning algorithm.

13. The non-transitory machine-readable medium of claim 11, wherein a portion of the first instructions comprise a frequency control module that issues control signals or commands to system and power interfaces or to a kernel power management interface in the kernel space.

14. The non-transitory machine-readable medium of claim 11, further having the eBPF governor stored thereon, wherein the eBPF governor comprises one of byte code or instructions configured to be executed in the kernel space.

15. The non-transitory machine-readable medium of claim 11, wherein the eBPF governor is a user customerized eBPF governor comprising:
an adaptive workload governor;
an uncore frequency governor;
a turbo boost governor;
a power state (P-state) polling governor; or
a hybrid power governor.

16. The non-transitory machine-readable medium of claim 11, further comprising second instructions configured to be run in the kernel space, wherein execution of the second instructions enable the compute platform to attach the eBPF governor to one or more attachment points that facilitate access to one or more of tracepoints, kernel probes (kprobes), and performance events, and wherein the data relating to power management and performance metrics and events is collected using one or more of the tracepoints, kprobes, and performance events.

17. A compute platform, comprising:
a central processing unit (CPU) having a plurality of CPU cores and circuitry external to the plurality of CPU cores comprising an uncore;
memory, operatively coupled to the CPU;
instructions, including an operating system, loaded in the memory or stored in a storage device operatively coupled to the CPU and configured to be executed on processor cores among the plurality of processor cores to enable the compute platform to:
load an extended Berkely Packet Filter (eBPF) governor from a user space into a kernel space of the operating system;
collect telemetry data relating to power management and performance metrics and events and store data relating to the power management and performance metrics and events in kernel space of the memory;
read data relating to the power management and performance metrics and events from the kernel space into the user space; and
dynamically adjust, based on the power management and performance metrics and events that have been read, at least one of,
a frequency of one or more of the CPU cores,
an idle state for one or more of the CPU cores; or
a frequency for the uncore.

18. The compute platform of claim 17, wherein a portion of the instructions comprises a power controller that performs the dynamic adjustment using an algorithm comprising one or more of a proportional-integral (PI), proportional-integral-derivative (PID), heuristic, and machine learning algorithm.

19. The compute platform of claim 17, wherein execution of the instructions enable the compute platform to attach the eBPF governor to one or more attachment points that facilitate access to one or more of tracepoints, kernel probes (kprobes), or performance events, and wherein the telemetry data relating to power management and performance metrics and events is collected using one or more of the tracepoints, kprobes, or performance events.

20. The compute platform of claim 17, wherein the eBPF governor is a user customized eBPF governor, and wherein execution of the instructions enables the compute platform to perform at least one of:
verify the user customized eBPF governor using a verifier implemented in the kernel space; and
when the eBPF governor comprises eBPF byte code, perform just-in-time compilation of the eBPF byte code via a JIT component implemented in the kernel space.
